(19) United States
(12) Patent Application Publication
(10) Pub. No.: US 2005/0272316 A1
(43) Pub. Date: Dec. 8, 2005

(54) Plug connector having a securing element with integrated damping element

(76) Inventors: Dieter Miksche, Gademhelm (DE); Volker Seipel, Bensheim (DE)

Correspondence Address: BARLEY SNYDER, LLC, 1000 WESTLAKES DRIVE, SUITE 275, BERWYN, PA, 19312, US

(21) Appl. No.: 11/116,916

(22) Filed: Apr. 28, 2005

(30) Foreign Application Priority Data
Apr. 28, 2004 (DE) 102004020934.0

(51) Int. Cl. H01R 13/514

(52) U.S. Cl. 439/752

(57) ABSTRACT

A plug connector is described which has a displaceably mounted securing element, which fixes the plug connector in latched connection with a plug connector socket in a locking position. To make the structure of the plug connector housing compact, the damping element is arranged in the securing element and may be displaced with the securing element. For a particularly compact structural shape, the damping element is plugged onto the contact elements of the plug connector and arranged displaceably relative to the contact elements.

### FIELD OF THE INVENTION

The invention relates to an electrical connector and in particular an igniter plug connector.

### BACKGROUND

In automotive technology, plug connectors are used for safety-relevant functions and have securing elements for securing the plug connector into a socket. To this end, the plug connectors comprise plug connector housings, on which a securing element is, for example, mounted displaceably, which element may be slid into a locked position when the plug connector is plugged in. In the locked position, locking elements of the securing element engage between catch elements of the plug connector and/or the socket in such a way that the plug connector is secured against removal from the socket. Due to the sliding function of the securing element, a relatively large housing structure is necessary for the plug connector. In addition, the plug connectors comprise damping elements, through which the electrical conductors of the plug connector pass. The arrangement of the damping element also makes the plug connector housing relatively bulky.

### SUMMARY

An object of the invention, among others, is to provide a plug connector, in particular an igniter plug connector for an airbag system, which has a displaceable securing element, a damping element and exhibits a compact structural shape.

In an embodiment of the invention, the contact element comprises a contact zone which is connected to a connection zone via a conduction portion. In addition, the damping element comprises a passageway, having a cross-section corresponding to the cross-section of the connection zone and of the conduction portion in such a way that the connection zone may be inserted through the passageway. In addition, the damping element may be displaced along the conduction portion and surrounds the conduction portion with a tight tolerance. A securing element comprises a receiving cavity with a resiliently mounted retaining lug. The damping element is inserted in the receiving cavity and is held in the receiving cavity by the retaining lug.

### BRIEF DESCRIPTION OF THE DRAWINGS

The invention is explained in more detail below with reference to the Figures, in which:

FIG. 1 is a perspective representation of a securing element and a damping element;

FIG. 2 shows a securing element with inserted damping element;

FIG. 3 shows a plug connector housing and two contact elements;

FIG. 4 shows a plug connector housing with fitted contact elements and a securing element with inserted damping element, ready for assembly;

FIG. 5 shows a plug connector housing with inserted securing element and fitted electrical conductors;

FIG. 6 shows a strain relief;

FIG. 7 shows an assembled plug connector housing with electrical conductors and a strain relief prior to assembly;

FIG. 8 shows a cross-section through a plug connector and a contact socket prior to plugging in of a plug connector;

FIG. 9 shows a cross-section through a plug connector and a socket, wherein the plug connector is located in a preliminary catch position; and

FIG. 10 shows a cross-section through a plug connector, which is plugged fully into the contact socket and is secured in the contact position by the securing element.

### DETAILED DESCRIPTION OF THE EMBODIMENTS

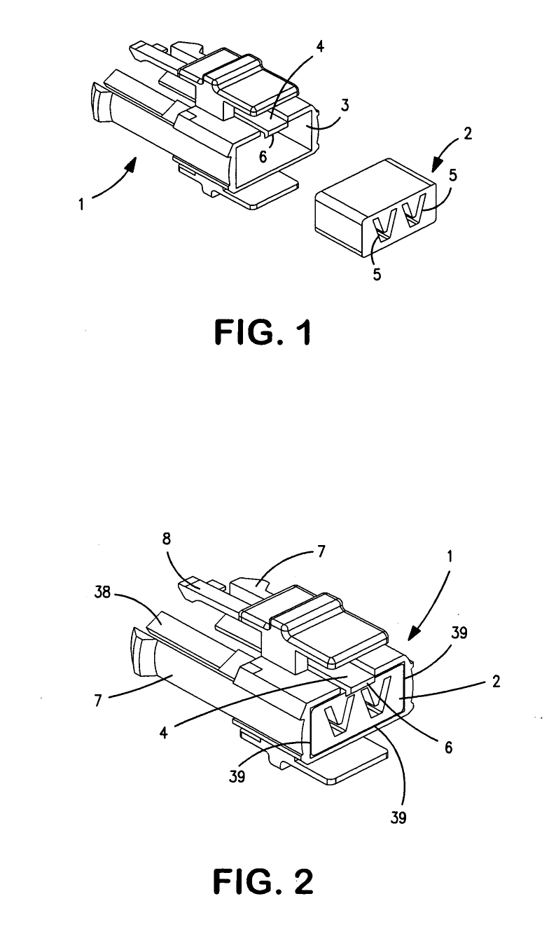

FIG. 1 is a perspective representation of a securing element 1 and a damping element 2, which may take the form of a ferrite element. Instead of the ferrite material, other materials may also be used to construct the damping element 2. The damping element 2 serves to suppress electrical interference signals. The securing element 1 comprises a receiving cavity 3, which is of substantially rectangular cross-section and is surrounded by a housing wall of the securing element 1. Adjacent the receiving cavity 3, there is provided a retaining lug 4 in the housing wall, which is mounted resiliently and comprises a retaining edge 6. The retaining edge 6 is arranged at the edge of the receiving cavity 3 and is oriented towards the receiving cavity 3. The damping element 2 consists substantially of a cross-sectionally rectangular ferrite block containing the two passageways 5. The passageways 5 are of U-shaped cross-section.

FIG. 2 shows a securing element 1, into whose receiving cavity 3 the damping element 2 is inserted. In the opening zone of the receiving cavity 3, the damping element 2 is held in the inserted position by the retaining edge 6 of the retaining lug 4. So that the damping element 2 cannot be pushed deeper into the securing element 1, corresponding retaining edges are constructed in the housing wall adjacent the receiving cavity 3. In this way, the damping element 2 is fixed in the securing element 1. The securing element 1 comprises first catch hooks 7 on opposing sides, which hooks 7 project from the securing element 1 in an insertion direction and are provided for latching together with a contact socket. In addition, a second catch hook 8 is formed on an upper side, which hook 8 projects from the securing element 1 in the insertion direction and is provided for retaining the securing element 1 in a pre-latched position on a plug connector housing for transportation. In addition, locking arms 38 are provided, which extend out of the securing element 1 in the insertion direction. In an embodiment, the damping element 2 is held on the securing element 1 by means of a bonding layer 39. The bonding layer 39 may take the form of an adhesive layer or a molded-in enveloping layer. For example, the damping element 2 may be encapsulated therein by injection molding. The retaining lug 4 may then be dispensed with.

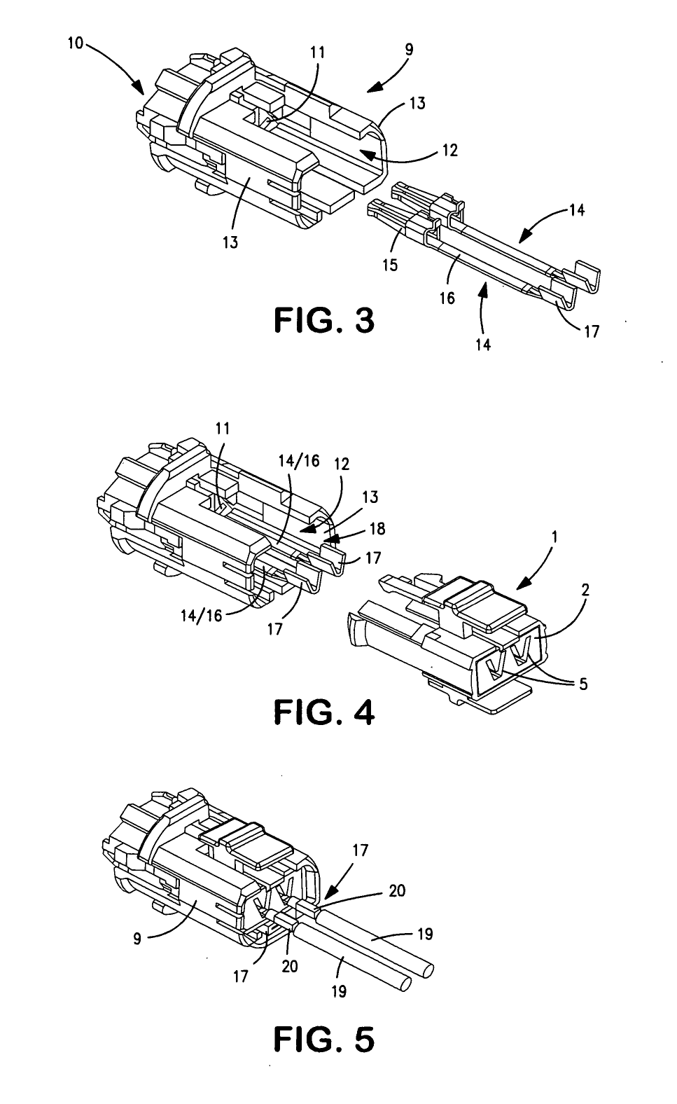

FIG. 3 shows a plug connector housing 9 comprising a contact plate 10. Adjacent the contact plate 10 there is formed a second receiving cavity 12, which is defined by a plug connector wall 13. Two contact receiving openings 11 are formed in the contact plate 10, which receiving openings 11 are arranged parallel to the longitudinal axis of the plug connector housing 9, start from the second receiving cavity 12, and pass through the entire contact plate 10. The second receiving cavity 12 exhibits a substantially rounded rectangular shape in cross-section.

In addition, FIG. 3 shows two contact elements 14. The contact elements 14 substantially comprise a contact zone 15, which is connected to a connection zone 17 via a conduction portion 16. The connection zone 17 serves in the connection of electrical conductors. The connection zone 17 may be a crimp zone, but it is also possible to provide a solder zone or weld zone for connection of the electrical conductor. The contact zone 15 substantially constitutes a contact tube provided to accommodate a contact pin. The conduction portion 16 is substantially rectangular in cross-section and takes the form of a ribbon conductor. Lugs are provided in the crimp zone 17 on opposing sides of the ribbon conductor, which lugs are designed for fixing the conductors of a cable. The contact elements 14 are preferably made in one piece from an electrically conductive plate material by stamping and forming.

FIG. 4 shows the plug connector housing 9 with inserted contact elements 14. The contact zones 15 have been inserted into the contact receiving openings 11 and fixed in the contact receiving openings 11 via clamp holders. The conduction portions 16 pass through the second receiving cavity 12 beyond an insertion opening 18 and the connection zones 17 are arranged outside the second receiving cavity 12. The securing element 1 with inserted damping element 2 is illustrated in front of the insertion opening 18 of the second receiving cavity 12. For assembly, the securing element 1 is inserted via the insertion opening 18 into the second receiving cavity 12. The connection zones 17 of the contact elements 14 are then pushed through the passageways 5 in the damping element 2. In addition, the securing element 1 is latched in a pre-latched position in the plug connector housing 9 by means of the second catch hook 8.

The cross-section of the passageways 5 is conformed to the contact elements 14 in such a way that the contact elements 14 may be pushed with one end through the passageways 5 of the damping element 2 and in addition the conduction portion 16, which is arranged in the damping element 2 when the securing element 1 is assembled, is tightly surrounded by the damping element 2, such that the electromagnetic attenuation of the damping element 2 on the interference signals flowing in the contact elements 14 is maintained.

FIG. 5 shows a plug connector with a plug connector housing 9, with contact elements 14 and with an inserted securing element 1. Cables 19 with electrical conductors 20 are fixed to the connection zones 17. The securing element 1 is located in a preliminary catch position and is fixed to the plug connector housing 9 by the second catch hook 8.

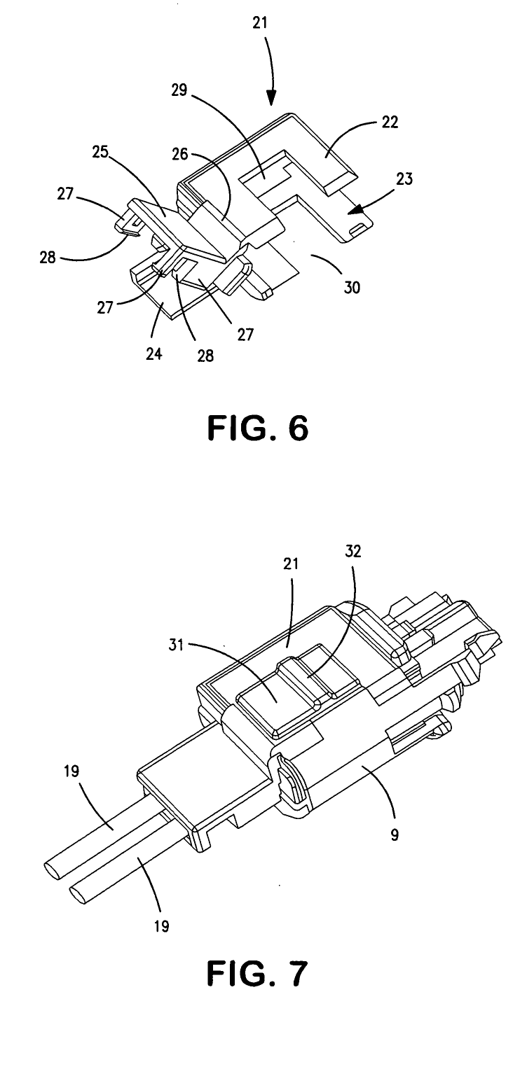

FIG. 6 shows a strain relief 21, which comprises a housing body 22, which comprises an opening 23 on one side. A first plate 24 is connected to the housing body 22 at a first end area, which first plate 24 is connected rigidly to the housing body 22. A second plate 25 is arranged over the first plate 24, which second plate 25 is connected foldably to the housing body 22 via a movable hinge 26. The second plate 25 comprises side walls 27 on opposing longitudinal sides, which side walls 27 comprise inwardly inclined catch projections 28 at the lower edges. On the insides of the first or second plates 24, 25, which face one another, clamping means are provided for clamping two cables 19 in place. Slots 29, 30 are formed in an upper side and a lower side of the housing body 22, which slots extend towards the open side of the housing body 22. The first and second slots 29, 30 allow the securing element 1 to be displaced relative to the housing body 22 in the assembled state.

FIG. 7 shows the plug connector with the plug connector housing 9 and attached cables 19, which are fitted to the plug connector housing 9 with a clamping connection by the strain relief 21. For assembly, the strain relief 21 is urged, with its second plate 25 open, as illustrated in FIG. 6, sideways onto the plug connector housing 9, as illustrated in FIG. 5. Next, the second plate 25 is folded downwards, wherein the two cables 19 are clamped firmly between the first and second plates 24, 25 and, in addition, the second plate 25 is latched to the first plate 24 by the catch projections 28. On the outside of the plug connector, actuating surfaces 31 of the securing element 1 are accessible. The actuating surfaces 31 are provided on opposing sides of the plug connector and each comprise a rib 32 extending transversely relative to the guidance direction of the plug connector.

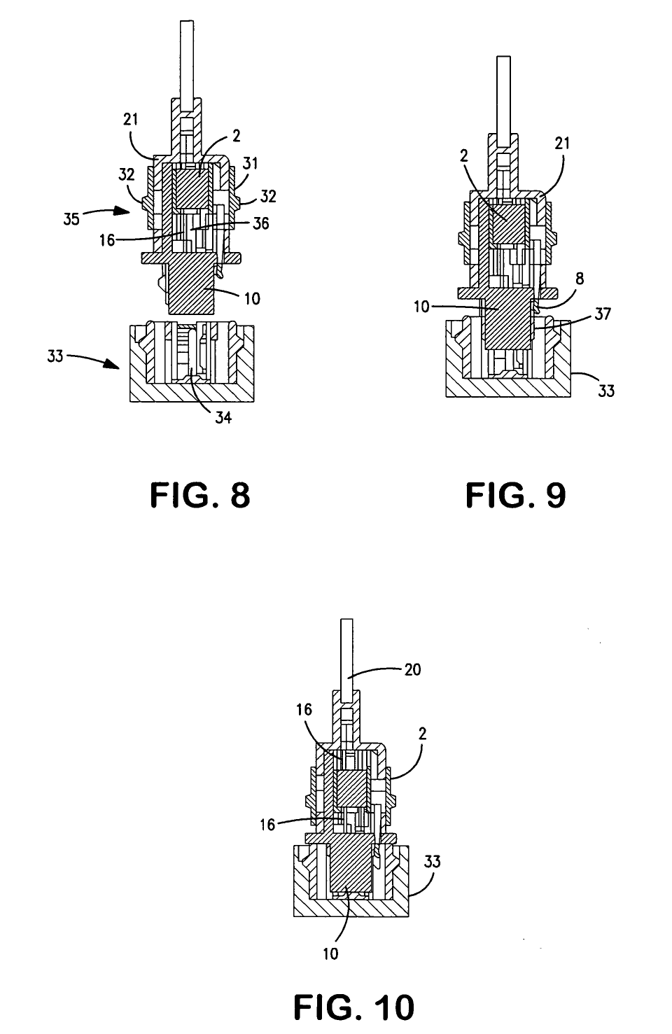

FIG. 8 is a cross-sectional representation of a plug connector socket 33, which in this exemplary embodiment takes the form of an igniter socket of an airbag deployment system. Recesses are provided in the plug connector socket 33 for receiving the plug connector. In the plug connector socket 33 there are provided two contact pins 34, which are provided for insertion into the contact receiving openings 11 of the contact plate 10 and into the contact zones 15 of the contact elements 14 of the plug connector. In the plug connector 35 there is located the securing element 1 in the pre-latched position, in which the damping element 2 is arranged in the upper area, i.e. in the first zone of the second receiving cavity 12. Between the damping element 2 and the contact plate 10 there is formed an insertion cavity 36, through which pass the conduction portions 16.

FIG. 9 shows a plug connector 35 partially inserted into the plug connector socket 33, which plug connector takes the form of part of the second receiving cavity 12, wherein, at the insertion depth illustrated, the second catch hook 8 is moved by an actuating surface 37 of the plug connector socket 33 out of the catch position. In this way, latching of the securing element 1 relative to the plug connector housing 9 is released, such that the securing element 1 may be displaced with the damping element 2 relative to the plug connector housing 9 and relative to the contact elements 14.

FIG. 10 shows a plug connector 35 fully inserted into the plug connector socket 33, in the latched position, wherein the securing element 1 is likewise located in the securing position and the damping element 2 has been inserted into the insertion cavity 36. In the securing position, the locking arms 38 of the securing element 1 are positioned in such a way that the latch connection between the plug connector 35 and the plug connector socket 33 cannot be released. In the catch position, the securing element 1 is held on the plug connector housing 9 and/or on the plug connector socket 33 by means of catch means, not shown. The latch connection of the securing element 1 may be released again by corresponding actuation of the catch means. Only after release of the catch means and sliding of the securing element 1 upwards relative to the plug connector housing 9 can the plug connector 34 be pulled out of the plug connector socket 33 again.

The plug connector according to the invention has the advantage that the plug connector housing has a compact structural shape. This advantage is achieved in that the damping element is mounted in the securing element.

The contact element of the plug connector preferably passes through the damping element. An even more compact structural shape is thus achieved, since the damping element is arranged in the vicinity of the contact zones of the contact element.

1. A plug connector comprising:
a housing with at least one contact element, which is mounted in the housing;
a catch hook provided for latching together with the contact socket;
a securing element, which is arranged movably in the housing, the securing element being movable from a rest position into a securing position, the securing element comprising a locking arm, which locks the position of the catch hook in the securing position and thus prevents the plug connector from being pulled out of the contact socket; and
a damping element for attenuating interference signals which pass through the contact element, the damping element being fixed to the securing element.

2. The plug connector according to claim 1 wherein the damping element comprises a passageway through which the contact element passes.

3. The plug connector according to claims 1, wherein the securing element comprises a receiving cavity with an insertion opening for the damping element and the damping element is arranged in the receiving cavity.

4. The plug connector according to claim 3, further comprising a resilient retaining lug arranged laterally on the receiving cavity, the retaining lug comprises a retaining edge, which engages the damping element in the receiving cavity.

5. The plug connector according to claim 3, further comprising a bonding layer which holds the damping element in the receiving cavity.

6. The plug connector according to claim 1, further comprising a second receiving cavity with an insertion opening, the second receiving cavity comprises a first zone and, adjacent thereto, an insertion cavity, the securing element may be inserted via the insertion opening into the first zone of the second receiving cavity, when the securing element is in the rest position, the damping element is arranged in the first zone, the securing element is mounted displaceably in the housing, and, on displacement of the securing element from the rest position into the securing position, the damping element may be moved into the insertion cavity.

7. A plug connector according to claim 1, wherein the contact element comprises a contact zone, a conduction portion and a connection zone for connection of a conductor, the housing comprises a contact plate, a contact hole is formed in the contact plate, the contact zone of the contact element is fixed in the contact hole, an insertion cavity is provided adjacent the contact zone, through which cavity the conduction portion of the contact element passes, when the securing element is in the rest position, the damping element is arranged adjacent the insertion cavity, the conduction portion passes through a passageway of the damping element and the contact zone and the connection zone are arranged outside the damping element, on moving the securing element into the securing position, the damping element may be moved into the insertion cavity, wherein the damping element performs a relative movement relative to the conduction portion.
